(19) United States
(12) Patent Application Publication
(10) Pub. No.: US 2026/0213070 A1
(43) Pub. Date: Jul. 23, 2026

(54) CAPACITOR

(71) Applicant: NICHICON CORPORATION, Kyoto-shi (JP)

(72) Inventors: Takashi NOSE, Kyoto-shi (JP); Takashi MORI, Kyoto-shi (JP); Takumi SAKAGUCHI, Kyoto-shi (JP); Yuya IHARA, Kyoto-shi (JP)

(21) Appl. No.: 19/568,189

(22) Filed: Mar. 16, 2026

Related U.S. Application Data
(63) Continuation of application No. PCT/JP2024/037702, filed on Oct. 23, 2024.

(30) Foreign Application Priority Data
Dec. 22, 2023 (JP) 2023-216499

(51) Int. Cl. H01G 2/20; H01G 4/224; H01G 4/252; H01G 4/33

(52) U.S. Cl. CPC H01G 2/20; H01G 4/224; H01G 4/252; H01G 4/33

(57) ABSTRACT

A capacitor includes: a capacitor element including a first and second end face electrode; a first bus bar including a first body section and a first lead-out section including a first external connection terminal; a second bus bar including a second body section and a second lead-out section including a second external connection terminal; a case; a sealing resin that seals the capacitor element, the first bus bar, and the second bus bar; and a vacuum-molded insulation resin member that insulates the first external connection terminal from the second external connection terminal, an inter-terminal distance between the first lead-out section and the second lead-out section that face each other being equal to or smaller than 0.8 mm, a creepage distance between the adjacent first lead-out section and second lead-out section being from rated voltage×0.005 mm to rated voltage×0.007 mm.

### CROSS-REFERENCE TO RELATED APPLICATIONS

This application is a continuation application of PCT International Application No. PCT/JP2024/037702, filed on Oct. 23, 2024, which claims the priority benefit of Japanese Patent Application No. 2023-216499, filed on Dec. 22, 2023, the entire contents of which are hereby incorporated by reference.

### BACKGROUND

### 1. Technical Field

The present invention relates to a capacitor.

### 2. Description of the Background

Conventionally, a film capacitor including a capacitor element, a pair of bus bars, an insulation member, a case, and a sealing resin is known (e.g., WO 2017/146013). The capacitor element includes a pair of end face electrodes. The pair of bus bars is electrically connected to the pair of end face electrodes of the capacitor element. The insulation member is disposed between the pair of bus bars and insulates each of the pair of bus bars. The case houses the capacitor element, part of the pair of bus bars, and part of the insulation member in its housing space. The sealing resin fills the housing space housing the capacitor element, the part of the pair of bus bars, and the part of the insulation member.

Film capacitors are widely used in inverter devices. With the increase in output and efficiency of inverter devices, it becomes necessary to reduce the parasitic inductance of film capacitors. Accordingly, it is necessary to reduce the thickness of the insulation member so as to shorten the inter-terminal distance between external connection terminals formed on the pair of bus bars.

### BRIEF SUMMARY

Typically, an insulation member in a conventional film capacitor is formed by resin injection molding. Accordingly, there is a limit for reducing the thickness of the insulation member, and it is difficult to reduce the parasitic inductance to a desired value or below.

It is conceivable also to form an insulation member using insulating paper instead of by resin molding. Although insulating paper is thin and can shorten the inter-terminal distance between a pair of bus bars (external connection terminals), it is difficult to three-dimensionally insulate between the pair of bus bars and to ensure a sufficient creepage distance between the pair of bus bars. In addition, as the strength of attachment of insulating paper to the bus bars is insufficient, it is not easy to handle insulating paper, and steps such as pre-pasting onto the bus bars are necessary, resulting in reduced work efficiency.

An object of the present invention is to provide a capacitor capable of reducing parasitic inductance while ensuring a sufficient creepage distance between a pair of bus bars.

A first aspect of the present invention provides a capacitor including:
a capacitor element including a first end face electrode and a second end face electrode;
a first bus bar including:
   a first body section electrically connected to the first end face electrode; and
   a first lead-out section including a first external connection terminal;
a second bus bar including:
   a second body section electrically connected to the second end face electrode; and
   a second lead-out section including a second external connection terminal adjacent to the first external connection terminal;
a case that houses the capacitor element, part of the first bus bar, and part of the second bus bar;
a sealing resin that seals the capacitor element, the first bus bar, and the second bus bar in a state in which the capacitor element, the first bus bar, and the second bus bar are housed in the case; and
a vacuum-molded insulation resin member that insulates the first lead-out section from the second lead-out section, an inter-terminal distance between the first lead-out section and the second lead-out section that face each other in a state in which the first lead-out section and the second lead-out section sandwich the insulation resin member being equal to or smaller than 0.8 mm, a creepage distance between the adjacent first lead-out section and second lead-out section being from rated voltage×0.005 mm to rated voltage×0.007 mm.

The capacitor according to the present invention is capable of reducing parasitic inductance while ensuring a sufficient creepage distance between a pair of bus bars.

### BRIEF DESCRIPTION OF DRAWINGS

FIG. 1A is a perspective view of a capacitor unit of a capacitor according to a first embodiment, and FIG. 1B is a perspective view of the capacitor unit of the capacitor according to the first embodiment as seen from another direction.

FIG. 2 is a plan view of the capacitor in FIGS. 1A and 1B.

FIG. 3 is a perspective view of part of the capacitor in FIGS. 1A and 1B.

FIG. 4 is a cross-sectional view taken along a line A-A in FIG. 3 as seen from the y-axis direction.

FIG. 5 is a perspective view of an insulation member of the capacitor in FIGS. 1A and 1B.

FIG. 6 is a cross-sectional view taken along a line B-B in FIG. 5.

FIG. 7 is a perspective view of a capacitor unit of a capacitor according to a second embodiment.

FIG. 8 is a plan view of the capacitor in FIG. 7.

FIG. 9 is a perspective view of part of the capacitor in FIG. 8.

FIG. 10 is a drawing of FIG. 9 as seen from the y-axis direction.

### DETAILED DESCRIPTION

### First Embodiment

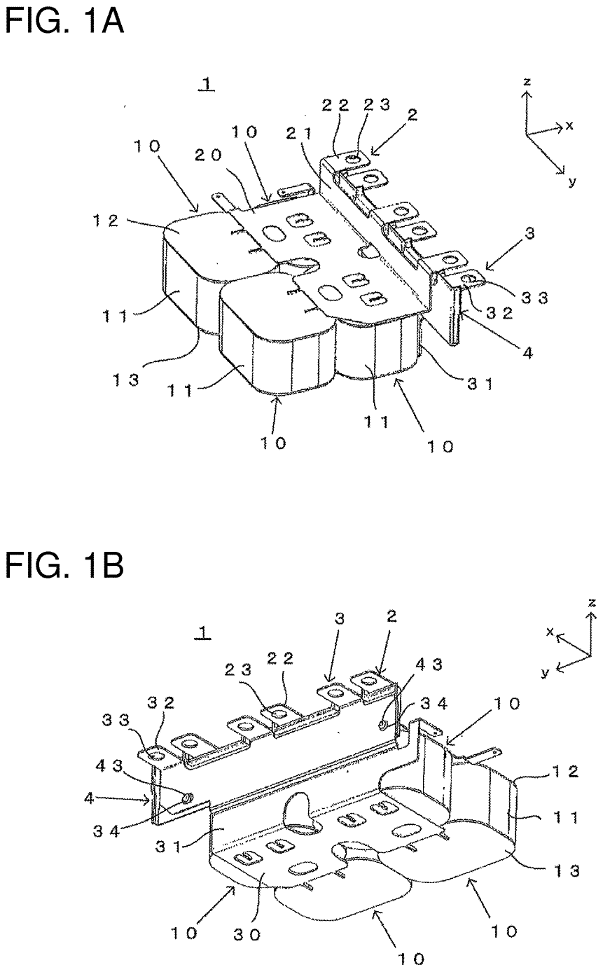

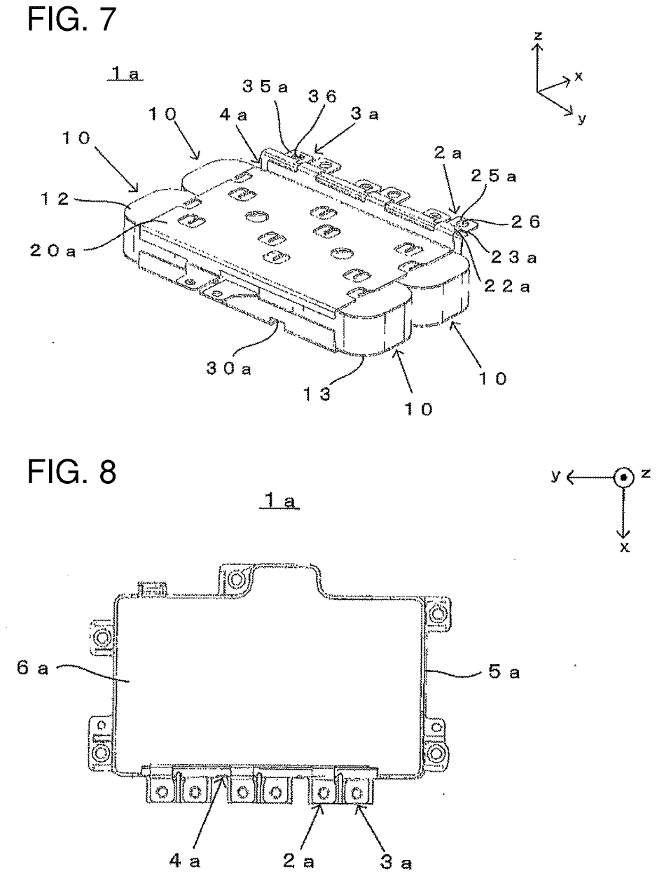

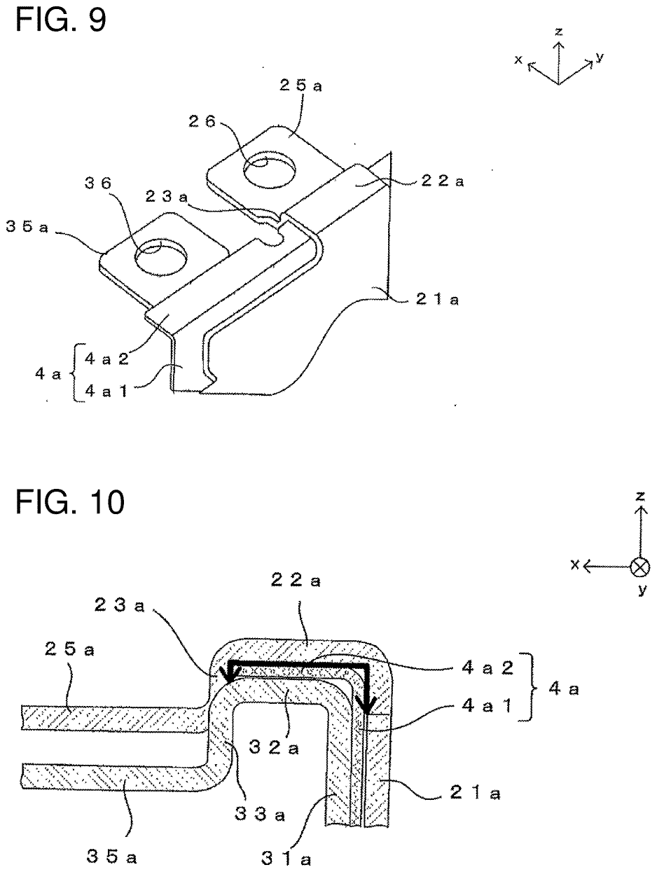

A capacitor 1 according to a first embodiment is explained with reference to FIGS. 1A to 6. FIGS. 1A to 6 are illustrated such that the x axis, the y axis, and the z axis are oriented in the same respective directions. Note that it is assumed below that a plan view of the capacitor 1 as seen from the z-axis positive side or negative side is an “xy plan view.” It is assumed that a plan view as seen from the y-axis positive side or negative side is an “xz plan view.” It is assumed that a plan view as seen from the x-axis positive side or negative side is a “yz plan view.” The same applies to FIGS. 7 to 10.

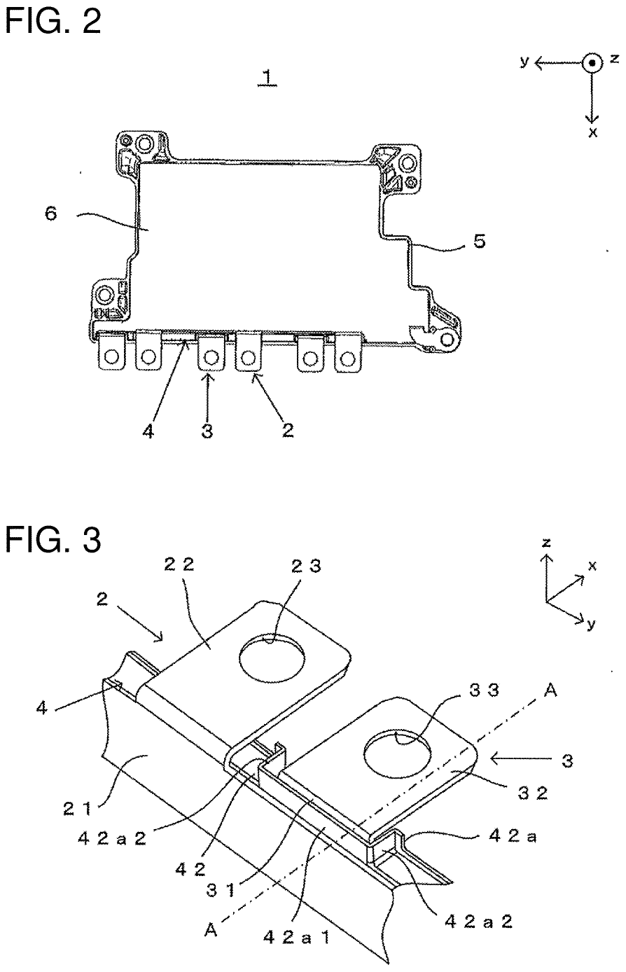

As illustrated in FIGS. 1A, 1B, and 2, the capacitor 1 includes a plurality of metallized-film capacitor elements (hereinbelow, capacitor elements) 10, a first bus bar 2, a second bus bar 3, an insulation member 4, a case 5, and a sealing resin 6.

As illustrated in FIGS. 1A and 1B, each capacitor element 10 includes an element body section 11, a first end face electrode 12, and a second end face electrode 13. The first end face electrode 12 is formed by spraying a metal such as zinc onto a first end face of the element body section 11. The second end face electrode 13 is formed by spraying a metal such as zinc onto a second end face of the element body section 11.

Each element body section 11 is formed by superimposing two metallized films which are dielectric films onto which aluminum has been vapor-deposited, winding or stacking the superimposed metallized films, and pressing them into a flat shape. Note that the element body section 11 is not limited to a configuration formed of metallized films which are dielectric films onto which aluminum has been vapor-deposited. For example, the element body section 11 may be formed of metallized films onto which another metal such as zinc or magnesium has been vapor-deposited. In addition, the element body section 11 may be formed of metallized films onto which a plurality of metals among such metals have been vapor-deposited. In addition, the element body section 11 may be formed of metallized films onto which an alloy of such metals has been vapor-deposited.

Each first end face electrode 12 is used as the P-pole side. Each second end face electrode 13 is used as the N-pole side. Note that each first end face electrode 12 may be used as the N-pole side, and each second end face electrode 13 may be used as the P-pole side.

Each of the first bus bar 2 and the second bus bar 3 is formed of a conductive material such as copper. The first bus bar 2 includes a body section 20 and a first lead-out section. The first lead-out section is drawn out from the body section 20. The first lead-out section includes a first upwardly-extending section 21 and a plurality of first external connection terminals 22. The body section 20 is sufficiently close to the first end face electrode 12 so as to allow soldering thereto and is electrically connected to the first end face electrode 12. The body section 20 has a plate-like shape whose outer profile in the xy plan view is substantially rectangular. The first upwardly-extending section 21 has a plate-like shape that extends upward in the z-axis positive direction from the x-axis positive-side end of the body section 20 and has an outer profile in the yz plan view which is substantially rectangular. Each first external connection terminal 22 extends substantially horizontally in the x-axis positive direction from the upper end of the first upwardly-extending section 21 positioned on the side opposite to the body section 20. Each first external connection terminal 22 includes a penetrating section 23 which is substantially circular in the xy plan view. The first bus bar 2 and an external wire are fastened using the penetrating section 23.

The second bus bar 3 includes a body section 30 and a second lead-out section. The second lead-out section is drawn out from the body section 30. The second lead-out section includes a second upwardly-extending section 31 and a plurality of second external connection terminals 32. Similarly to the first bus bar 2, the body section 30 is sufficiently close to the second end face electrode 13 so as to allow soldering thereto and is electrically connected to the second end face electrode 13. The body section 30 has a plate-like shape whose outer profile in the xy plan view is substantially rectangular. The second upwardly-extending section 31 has a plate-like shape that extends upward in the z-axis positive direction from the x-axis positive-side end of the body section 30 and has an outer profile in the yz plan view which is substantially rectangular. Each second external connection terminal 32 extends substantially horizontally in the x-axis positive direction from the upper end of the second upwardly-extending section 31 positioned on the side opposite to the body section 30. Each second external connection terminal 32 includes a penetrating section 33 which is substantially circular in the xy plan view. The second bus bar 3 and an external wire are fastened using the penetrating section 33.

The first bus bar 2 is used as the P-pole-side bus bar. The second bus bar 3 is used as the N-pole-side bus bar. Note that the first bus bar 2 may be used as the N-pole-side bus bar, and the second bus bar 3 may be used as the P-pole-side bus bar.

The insulation member 4 is disposed between the first upwardly-extending section 21 of the first bus bar 2 and the second upwardly-extending section 31 of the second bus bar 3. Thereby, the first bus bar 2 is insulated from the second bus bar 3. As illustrated in FIG. 5, the insulation member 4 includes a vertical insulation section 41, a horizontal insulation section 42, a plurality of fitting protrusions 43 (two fitting protrusions 43 in the present embodiment). The vertical insulation section 41 is disposed between the first upwardly-extending section 21 of the first bus bar 2 and the second upwardly-extending section 31 of the second bus bar 3. The vertical insulation section 41 has a plate-like shape which is substantially rectangular in the yz plan view. The horizontal insulation section 42 extends integrally in the x-axis positive direction from the z-axis positive-side end of the vertical insulation section 41. The horizontal insulation section 42 is disposed between the first external connection terminal 22 and the second external connection terminal 32. Each fitting protrusion 43 fits to a corresponding one of a plurality of fitting holes that are formed through the second bus bar 3 and mentioned later, thereby providing positioning.

The insulation member (insulation resin member) 4 is formed by vacuum-molding an insulation resin material. For example, the insulation resin material is PP (polypropylene), PET (polyethylene terephthalate), PBT (polybutylene terephthalate), PC (polycarbonate), PPS (polyphenylene sulfide), SPS (syndiotactic polystyrene), PPA (polyphthalamide), PA 66 (polyamide/nylon 66), or LCP (liquid crystal polymer). In particular, the insulation resin material is preferably a resin material belonging to Group I among insulation materials defined in the insulation standard (JIS60664) of the Japanese Industrial Standards.

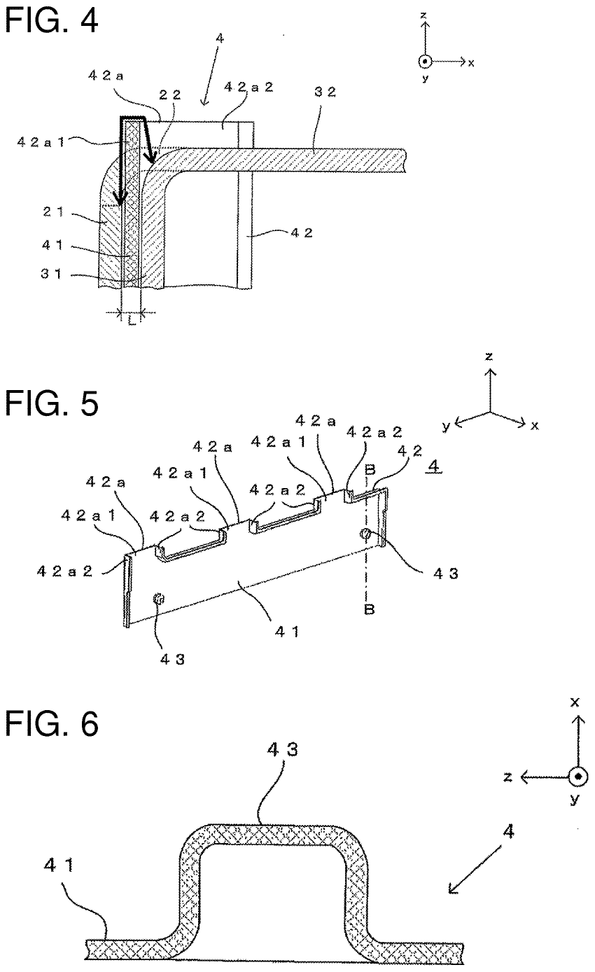

By forming the insulation member 4 by vacuum-molding a resin material belonging to Group I among the insulation materials, the insulation member 4 with a thinness equal to or smaller than 0.8 mm can be formed. In contrast to conventional resin injection molding, which could only reduce the thickness to approximately 1.0 mm, the present embodiment makes it possible to make the insulation member 4 thinner than in conventional techniques. As represented by thin solid arrows in FIG. 4, with the insulation member 4 sandwiched between the first bus bar 2 and the second bus bar 3, an inter-terminal distance L between the first lead-out section (first upwardly-extending section 21) and the second lead-out section (second upwardly-extending section 31) can be made equal to or smaller than 0.8 mm.

As illustrated in FIGS. 3 to 5, surrounding sections 42a are formed at the horizontal insulation section 42. Each surrounding section 42a surrounds a second external connection terminal 32. As illustrated in FIGS. 3 to 5, each surrounding section 42a includes a main surface 42a1 and two bent sections 42a2. The main surface 42a1 extends upward in the z-axis positive direction along a side surface continuous with a second upwardly-extending section 31, which is the root of a second external connection terminal 32. The two bent sections 42a2 are bent in the x-axis positive direction at both ends in the y-axis direction of the main surface 42a1 and are formed integrally. The surrounding section 42a is formed integrally in a U-shape in the xy plan view so as to surround part of three side surfaces of the second external connection terminal 32.

The surrounding sections 42a make it possible to ensure a sufficient creepage distance between the adjacent first lead-out section and second lead-out section represented by thick solid arrows in FIG. 4. A creepage distance of rated voltage×0.005 mm to rated voltage×0.007 mm can be surely ensured compactly so as to fit within a predetermined size.

As illustrated in FIG. 6, the fitting protrusions 43 are formed at the vertical insulation section 41 during vacuum molding such that cross-sections of the fitting protrusions 43 in the xz plane have substantially rectangular shapes protruding in the x-axis positive direction. The fitting protrusions 43 fit to a plurality of fitting holes 34 (two fitting holes 34) formed through the second upwardly-extending section 31 of the second bus bar 3. Thereby, positioning at the time when the insulation member 4 is interposed between the first bus bar 2 and the second bus bar 3 becomes easier.

For example, the case 5 can be formed of various materials such as resins such as PPS or PBT, organic materials such as plastic, inorganic materials such as ceramics, and the like.

The housing region inside the case 5 houses parts of a capacitor unit including the plurality of capacitor elements 10, the first bus bar 2, the second bus bar 3, and the insulation member 4. For example, the sealing resin 6 formed of an epoxy resin fills the housing space of the case 5 housing the part of the capacitor unit and seals the part of the capacitor unit.

The sealing resin 6 is not limited to an epoxy resin, but may be various insulation materials adopted as sealing resins of an electronic component. Note that the sealing resin 6 is formed by being injected in a liquid state into the case 5 through an opening of the case and then cured.

According to the first embodiment, using the insulation member 4 formed by vacuum-molding a material belonging to Material Group I among insulation materials defined in the insulation standard of the Japanese Industrial Standards, the first bus bar 2 can be insulated from the second bus bar 3 in a three-dimensional structure using the insulation member 4 which is thinner than an injection-molded insulation resin member and with a strength which is higher than that of insulating paper. Thereby, the parasitic inductance can be reduced while ensuring a sufficient creepage distance between the first lead-out section and the second lead-out section. In addition, unlike insulating paper, handling does not become complicated, and workability is superior.

In addition, using the vacuum-molded insulation member 4, a surrounding section 42a surrounding three side surfaces of each second external connection terminal 32 is formed at the insulation member 4. Thereby, a creepage distance of rated voltage×0.005 mm to rated voltage×0.007 mm can be ensured compactly between the first lead-out section and the second lead-out section so as to fit within a predetermined size.

In addition, by causing the fitting protrusions 43 formed at the insulation member 4 to fit to the fitting holes 34 formed through the second bus bar 3, positioning at the time when the insulation member 4 is interposed between the first bus bar 2 and the second bus bar 3 can be performed easily. At this time, compared to a case in which an insulation member is formed of insulating paper, the vacuum-molded insulation resin member has higher strength, is very easy to handle, and is superior in workability. Accordingly, this contributes to improving the efficiency of capacitor assembly work.

### Second Embodiment

A capacitor 1a according to a second embodiment is explained in detail with reference to FIGS. 7 to 10. Similarly to the capacitor 1 according to the first embodiment, the capacitor 1a according to the second embodiment includes a plurality of metallized-film capacitor elements (capacitor elements) 10, a first bus bar 2a, a second bus bar 3a, an insulation member 4a, a case 5a, and a sealing resin 6a. The configuration of the capacitor 1a according to the second embodiment is different from the capacitor 1 according to the first embodiment in the following respects.

In the second embodiment, the shapes of the first bus bar and the second bus bar are different from the shapes of the first bus bar 2 and the second bus bar 3 according to the first embodiment.

As illustrated in FIGS. 7 to 10, the first bus bar 2a includes a body section 20a and a first lead-out section. The first lead-out section includes a first upwardly-extending section 21a, a first extending section 22a, a first downwardly-extending section 23a, and a plurality of first external connection terminals 25a (three first external connection terminals 25a in the present embodiment). The body section 20a is electrically connected to the first end face electrode 12. The first upwardly-extending section 21a extends upward substantially vertically in the z-axis positive direction from the x-axis positive-side end of the body section 20a. The first extending section 22a extends substantially horizontally in the x-axis positive direction from the upper end of the first upwardly-extending section 21a. The first downwardly-extending section 23a extends downward in the z-axis negative direction from the x-axis positive-side end of the first extending section 22a. The first external connection terminal 25a extends substantially horizontally in the x-axis positive direction from the lower end of the first downwardly-extending section 23a.

As illustrated in FIGS. 7 to 10, the second bus bar 3a includes a body section 30a and a second lead-out section. The second lead-out section includes a second upwardly-extending section 31a, a second extending section 32a, a second downwardly-extending section 33a, and a plurality of second external connection terminals 35a (three second external connection terminals 35a in the present embodiment). The body section 30a is electrically connected to the second end face electrode 13. The second upwardly-extending section 31a extends upward substantially vertically in the z-axis positive direction from the x-axis positive-side end of the body section 30a. The second extending section 32a extends substantially horizontally in the x-axis positive direction from the upper end of the second upwardly-extending section 31a. The second downwardly-extending section 33a extends downward in the z-axis negative direction from the x-axis positive-side end of the second extending section 32a. The second external connection terminal 35a extends substantially horizontally in the x-axis positive direction from the lower end of the second downwardly-extending section 33a.

Each first external connection terminal 25a includes a penetrating section 26 which is substantially circular in the xy plan view. Each second external connection terminal 35a includes a penetrating section 36 which is substantially circular in the xy plan view. The first bus bar 2a and an external wire are fastened using the penetrating section 26. The second bus bar 3a and an external wire are fastened using the penetrating section 36.

In addition, similarly to the insulation member 4 according to the first embodiment, for example, the insulation member (insulation resin member) 4a is PP, PET, PBT, PC, PPS, SPS, PPA, PA66, or LCP. In particular, the insulation resin material is preferably a resin material belonging to Group I among insulation materials defined in the insulation standard (JIS60664) of the Japanese Industrial Standards.

The insulation member 4a has an L-shape in the xz plan view. Substantially similarly to the insulation member 4 according to the first embodiment, the insulation member 4a includes a vertical insulation section 4a1, a horizontal insulation section 4a2, and a plurality of fitting protrusions (not illustrated). The vertical insulation section 4a1 is disposed between the first upwardly-extending section 21a of the first bus bar 2a and the second upwardly-extending section 31a of the second bus bar 3a. The vertical insulation section 4a1 has a plate-like shape which is substantially rectangular in the yz plan view. The horizontal insulation section 4a2 extends integrally in the x-axis positive direction from the z-axis positive-side end of the vertical insulation section 4a1. The horizontal insulation section 4a2 is disposed between the first extending section 22a and the second extending section 32a. Each fitting protrusion fits to a corresponding one of a plurality of fitting holes (not illustrated) that are formed through the second bus bar 3a, thereby providing positioning.

Unlike the insulation member 4 according to the first embodiment, the insulation member 4a according to the present embodiment does not have surrounding sections. However, the horizontal insulation section 4a2 is disposed between the first extending section 22a and the second extending section 32a. Thereby, as represented by thick solid arrows in FIG. 10, it is possible to ensure a sufficient creepage distance between the adjacent first lead-out section and second lead-out section. A creepage distance of rated voltage×0.005 mm to rated voltage×0.007 mm can be ensured compactly so as to fit within a predetermined size.

According to the second embodiment, similarly to the first embodiment, using the insulation member 4a formed by vacuum-molding a resin material belonging to Material Group I among insulation materials defined in the insulation standard of the Japanese Industrial Standards, the first bus bar 2a can be insulated from the second bus bar 3a in a three-dimensional structure using the insulation member 4a which is thinner than an injection-molded insulation resin member and with a strength which is higher than that of insulating paper. Thereby, the parasitic inductance can be reduced while ensuring a sufficient creepage distance between the first lead-out section and the second lead-out section. In addition, unlike insulating paper, handling does not become complicated and workability is superior.

In addition, the insulation member 4a includes the horizontal insulation section 4a2 disposed between the first extending section 22a and the second extending section 32a. Accordingly, even without surrounding sections like the ones in the first embodiment, a creepage distance of rated voltage×0.005 mm to rated voltage×0.007 mm can be ensured compactly between the adjacent first lead-out section and second lead-out section so as to fit within a predetermined size.

Note that the present invention is not limited to the configuration described above, and various design modifications can be made within the scope of matters described in claims.

The present invention can be applied widely to capacitors including an insulation resin member that is disposed between a pair of bus bars and insulates each of the pair of bus bars.

### REFERENCE SIGNS LIST

1, 1a: capacitor
2, 2a: first bus bar
3, 3a: second bus bar
4, 4a: insulation member (insulation resin member)
5, 5a: case
6, 6a: sealing resin
22, 25a: first external connection terminal
21, 21a: first upwardly-extending section
22a: first extending section
23a: first downwardly-extending section
32, 35a: second external connection terminal
31, 31a: second upwardly-extending section
32a: second extending section
33a: second downwardly-extending section
41, 4a1: vertical insulation section
42, 4a2: horizontal insulation section
42a: surrounding section

What is claimed is:

1. A capacitor comprising:
a capacitor element including a first end face electrode and a second end face electrode;
a first bus bar including:
a first body section electrically connected to the first end face electrode; and
a first lead-out section including a first external connection terminal;
a second bus bar including:
a second body section electrically connected to the second end face electrode; and
a second lead-out section including a second external connection terminal adjacent to the first external connection terminal;
a case that houses the capacitor element, part of the first bus bar, and part of the second bus bar;
a sealing resin that seals the capacitor element, the first bus bar, and the second bus bar in a state in which the capacitor element, the first bus bar, and the second bus bar are housed in the case; and
a vacuum-molded insulation resin member that insulates the first lead-out section from the second lead-out section, an inter-terminal distance between the first lead-out section and the second lead-out section that face each other in a state in which the first lead-out section and the second lead-out section sandwich the insulation resin member being equal to or smaller than 0.8 mm, a creepage distance between the adjacent first lead-out section and second lead-out section being from rated voltage×0.005 mm to rated voltage×0.007 mm.

2. The capacitor according to claim 1, wherein
the insulation resin member is formed of a material belonging to Material Group I in insulation materials defined in an insulation standard of the Japanese Industrial Standards.

3. The capacitor according to claim 1, wherein
the insulation resin member includes a surrounding section that surrounds part of mutually adjacent side surfaces of at least one of the first lead-out section or the second lead-out section.

4. The capacitor according to claim 1, wherein
the first lead-out section includes:
a first upwardly-extending section that extends upward substantially vertically from the first body section; and
a first extending section that extends substantially horizontally from an upper end of the first upwardly-extending section; and
a first downwardly-extending section that extends downward from an end of the first extending section,
the second lead-out section includes:
a second upwardly-extending section that extends upward substantially vertically from the second body section;
a second extending section that extends substantially horizontally from an upper end of the second upwardly-extending section; and
a second downwardly-extending section that extends downward from an end of the second extending section, and
the insulation resin member includes:
a vertical insulation section that is interposed between the first upwardly-extending section and the second upwardly-extending section; and
a horizontal insulation section that is interposed between the first extending section and the second extending section.

5. The capacitor according to claim 2, wherein
the insulation resin member includes a surrounding section that surrounds part of mutually adjacent side surfaces of at least one of the first lead-out section or the second lead-out section.

6. The capacitor according to claim 2, wherein
the first lead-out section includes:
a first upwardly-extending section that extends upward substantially vertically from the first body section; and
a first extending section that extends substantially horizontally from an upper end of the first upwardly-extending section; and
a first downwardly-extending section that extends downward from an end of the first extending section,
the second lead-out section includes:
a second upwardly-extending section that extends upward substantially vertically from the second body section;
a second extending section that extends substantially horizontally from an upper end of the second upwardly-extending section; and
a second downwardly-extending section that extends downward from an end of the second extending section, and
the insulation resin member includes:
a vertical insulation section that is interposed between the first upwardly-extending section and the second upwardly-extending section; and
a horizontal insulation section that is interposed between the first extending section and the second extending section.
